(19) United States
(12) Patent Application Publication
(10) Pub. No.: US 2023/0258461 A1
(43) Pub. Date: Aug. 17, 2023

(54) INTERACTIVE ANALYTICAL FRAMEWORK FOR MULTIMODAL TRANSPORTATION

(71) Applicant: Hitachi, Ltd., Tokyo (JP)

(72) Inventors: Ramyar Saeedi, Santa Clara, CA (US); Malarvizhi Sankaranarayanasamy, Mountain View, CA (US); Prasun Singh, San Jose, CA (US); Rahul Vishwakarma, Sunnyvale, CA (US); Ravigopal Vennelakanti, San Jose, CA (US)

(21) Appl. No.: 17/674,562

(22) Filed: Feb. 17, 2022

(51) Int. Cl. G08G 9/00

(52) U.S. Cl. CPC G08G 9/00

(57) ABSTRACT

An apparatus for providing recommended solutions for a multi-mode transportation problem associated with a multi-mode transportation network. The apparatus may include a memory and at least one processor coupled to the memory. The at least one processor may be configured to receive transportation-related data regarding a plurality of different modes of transportation. The apparatus may further be configured to generate a single-mode data set for each of the plurality of different modes of transportation. The apparatus may also be configured to generate problem-specific harmonized data for the multi-mode transportation network from the received transportation-related data. The apparatus may further be configured to provide a set of recommended solutions for the multi-mode transportation problem based on the problem-specific harmonized data.

### FIELD

The present disclosure is generally directed to an analytic framework for integrating information from multiple modes of transportation in a multi-modal transportation network.

### RELATED ART

The growing urban population and the changes in travel behavior with the help of the internet of things (IoT) has created a market for new generations of transportation systems. Multi-Modal Mobility (MMM) is one of the major trends that is driving this transformation toward seamless and reliable transportation. There is currently no consideration on how interactions between modes of transportation can be exploited to build more accurate integrated models that could lead to better planning both for each mode individually and for the multi-modal ecosystem. FIG. 1 illustrates that in a prior art implementation 110 each transportation mode 112-116 may be analyzed independently. Due to the disconnected infrastructure of different modes of transportation, there are challenges in developing advanced analytical tools to optimize the operational and service functions of different modes.

### SUMMARY

Example implementations described herein involve an innovative framework for analysis and recommendation generation.

Aspects of the present disclosure include a method for providing recommended solutions for a multi-mode transportation problem associated with a multi-mode transportation network. The method may include receiving transportation-related data regarding a plurality of different modes of transportation. The method may further include generating a single mode data set for each of the plurality of different modes of transportation. The method may also include generating problem-specific harmonized data for the multi-mode transportation network from the received transportation-related data and providing a set of recommended solutions for the multi-mode transportation problem based on the problem-specific harmonized data.

Aspects of the present disclosure include a non-transitory computer readable medium, storing instructions for execution by a processor, which can involve instructions for providing recommended solutions for a multi-mode transportation problem associated with a multi-mode transportation network. The instructions may include instructions for receiving transportation-related data regarding a plurality of different modes of transportation. The instructions may further include instructions for generating a single mode data set for each of the plurality of different modes of transportation. The instructions may include instructions for generating problem-specific harmonized data for the multi-mode transportation network from the received transportation-related data. The instructions may also include providing a set of recommended solutions for the multi-mode transportation problem based on the problem-specific harmonized data.

Aspects of the present disclosure include a system for providing recommended solutions for a multi-mode transportation problem associated with a multi-mode transportation network. The system may include means for receiving transportation-related data regarding a plurality of different modes of transportation. The system may also include means for generating a single mode data set for each of the plurality of different modes of transportation. The system may also include means for generating problem-specific harmonized data for the multi-mode transportation network from the received transportation-related data. The system may further include means for providing a set of recommended solutions for the multi-mode transportation problem based on the problem-specific harmonized data.

Aspects of the present disclosure include an apparatus, which can involve a processor, configured to receive transportation-related data regarding a plurality of different modes of transportation. The processor may also be configured to generate a single mode data set for each of the plurality of different modes of transportation. The processor may further be configured to generate problem-specific harmonized data for the multi-mode transportation network from the received transportation-related data. The processor may also be configured to provide a set of recommended solutions for the multi-mode transportation problem based on the problem-specific harmonized data.

### BRIEF DESCRIPTION OF DRAWINGS

FIG. 1 illustrates that in a prior art implementation, each transportation mode may be analyzed independently.

FIG. 2 illustrates a proposed framework for analysis of a multi-modal transportation network, in accordance with various aspects of the present disclosure.

FIG. 3 illustrates an embodiment of a data integration component, in accordance with various aspects of the present disclosure.

FIG. 4 illustrates a set of single mode platform types.

FIG. 5 illustrates a set of geographical/geological segments, including nodes, links, and routes for a portion of a single-mode transportation network, in accordance with various aspects of the present disclosure.

FIG. 6 is a diagram illustrating a portion of a multi-mode network and associated single-mode databases and an aggregated (multi-mode) database, in accordance with various aspects of the present disclosure.

FIG. 7 is a diagram illustrating a setof operations associated with building single-mode and multi-mode databases, in accordance with various aspects of the present disclosure.

FIG. 8 further illustrates that the graph databases may be used to produce a set of models, in accordance with various aspects of the present disclosure.

FIG. 9 illustrates an example of a pipeline for providing a solution to a route planning problem for a particular mode of transportation, in accordance with various aspects of the present disclosure.

FIG. 10 is a flow diagram of a method of providing recommended solutions for a multi-mode transportation problem.

FIG. 11 is a flow diagram of a method of providing recommended solutions for a multi-mode transportation problem.

FIG. 12 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

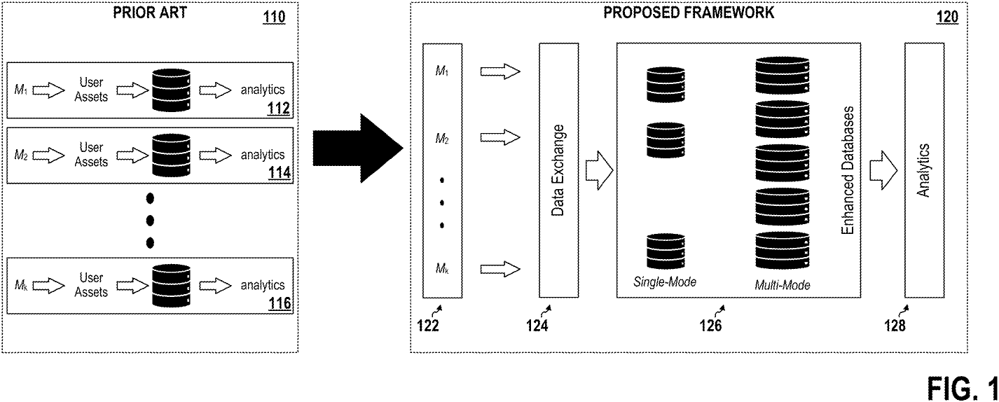

FIG. 1 illustrates that in a prior art implementation 110, each transportation mode 112-116 may be analyzed independently. Due to the disconnected infrastructure of different modes of transportation, there are challenges in developing advanced analytical tools for optimizing the operational and service functions of different modes. The proposed framework 120 involves representing a multi-modal transportation network using a plurality of modes with different specifications. Each mode in a set of modes 122 has its own assets and data collection operation. The proposed framework 120 provides a data exchange 124 for collecting single-mode data to build a set of single mode databases and a multi-mode database in a set of enhanced databases 126. The integrated data in the set of enhanced databases 126 may then be analyzed by an analytics element 128. The proposed framework 120 may enable forecasting and planning for a specific spatial scale, time scale, and mode level exploiting the interaction between different modes and their effect on each other.

The framework provides the possibility of both single-mode and multi-mode decision-making. The proposed framework may use the integrated information of multiple modes of transportation to make better and more accurate forecasting, planning, and/or recommendation. Furthermore, the proposed framework may provide a generalizable solution to perform analytics in different temporal (e.g., hourly, daily, yearly) and spatial (e.g., station, zip code, county, area) scales. This generalization may be built based on geological segmentation, each segment being indicative of an area belonging to the operation area of the multi-modal transportation network, and each segment having a representative feature vector of that segment. Each segment of the multi-modal transportation network includes information about public transport networks, road networks, or other transportation networks inside of the segment. Additionally, the framework also exploits external data resources, loT data, and users’ information for making better decisions.

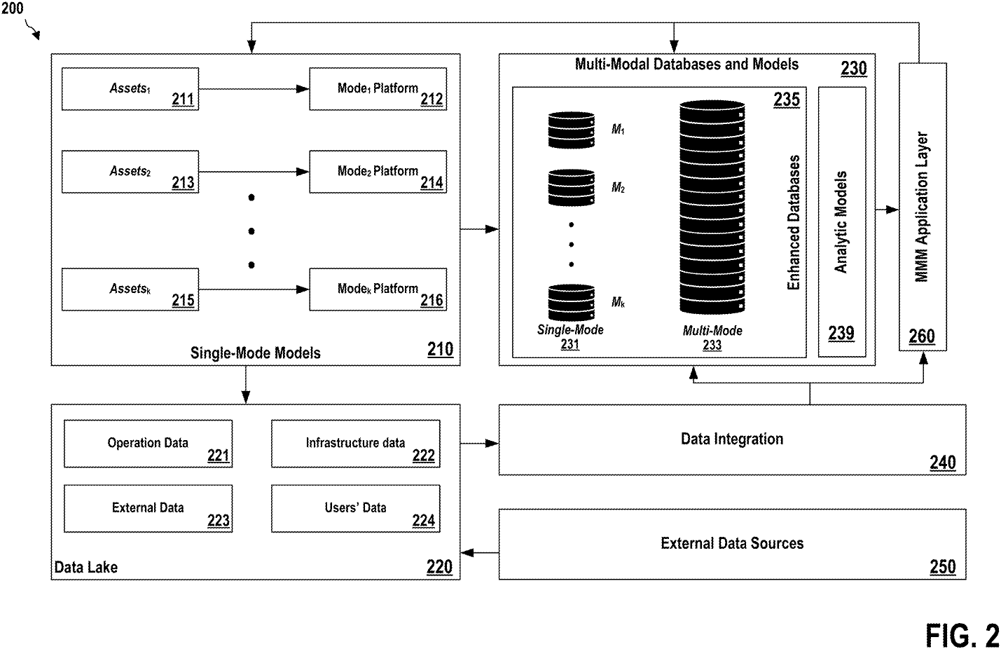

FIG. 2 illustrates a proposed framework 200 for analysis of a multi-modal transportation network. Proposed framework 200 includes single-mode models 210, a data lake 220, multi-modal databases and models 230, a data integration component 240, a set of external data sources 250, and an MMM application layer 260. The single-mode models 210 may include sets of assets 211, 213, and 215 that are each associated with a single mode of transportation and a corresponding single-mode platform 212, 214, and 216. A set of assets 211, 213, or 215 may include resources associated with a particular mode of transportation such as stations, vehicles, routes, and so on. In some aspects, each single-mode platform 212, 214, or 216 may receive operation data 221 (e.g., vehicle tracking, ridership data, traffic data, etc.) and asset information (e.g., infrastructure data 222), process the received information, and analyze the processed data to provide single-mode transportation recommendations.

The data lake 220, in some aspects, includes operation data 221 for multiple modes of transportation. The operation data 221 may include spatial-temporal data to describe assets and their relations, e.g., information regarding ridership, geolocations, traffic, delays, events, and so on. For example, we can assign demands to each station as time series data showing the demand through time. The infrastructure data 222 may include information regarding stations, vehicles, routes, and/or other infrastructure associated with the multiple modes of transportation. The infrastructure data 222 may be used, in some aspects, to build the static part of both single mode and multimode networks. In some aspects, the static component of the single-mode and multi-mode networks include graphs with edges and nodes. Each node, in some aspects, corresponds to an asset (e.g., a station, bus stop, parking lot, segment, etc.) for a multi-mode or single-mode network and each edge corresponds to a connection between assets (e.g., a bus route, road, etc.) for the multi-mode and single mode networks.

The external data 223 may include demographic data, weather data, census data, people flow, points of interest, or additional data (e.g., received from external data sources 250). For example, the external data sources 250 may include external devices such as loT devices (e.g., smart devices, watches, etc.) that may provide data collected from the IoT devices such as users’ ticketing, questionnaires, gated entries, traffic detection sensors, flow estimation cameras, or other available IoT data. The user data 224 may include spatial-temporal activity patterns associated with a plurality of users.

Data integration component 240 receives data from data lake 220 and processes data regarding the multiple modes of transportation to provide data to the multi-modal databases and models 230 and the MMM application layer 260. MMM application layer 260, in some aspects, provides or generates integrated analytics for different purposes for the multi-modal network and/or ecosystem. For example, the MMM application layer may provide a demand forecast functionality, traffic management systems for MMM, trip planning functionality, or other desired analysis of the MMM data in the set of enhanced databases 235. The data integration component 240 may provide data that has been cleaned and synchronized for analytics to each of a set of single-mode databases 231 associated with single-mode networks and a multi-modal database 233 associated with the multi-modal network. The set of single-mode database 231 and the multi-modal database 233 may make up a set of enhanced databases 235. The data integration component 240 may additionally provide analytic models 239 (or information for generating analytical models associated with analytic models 239).

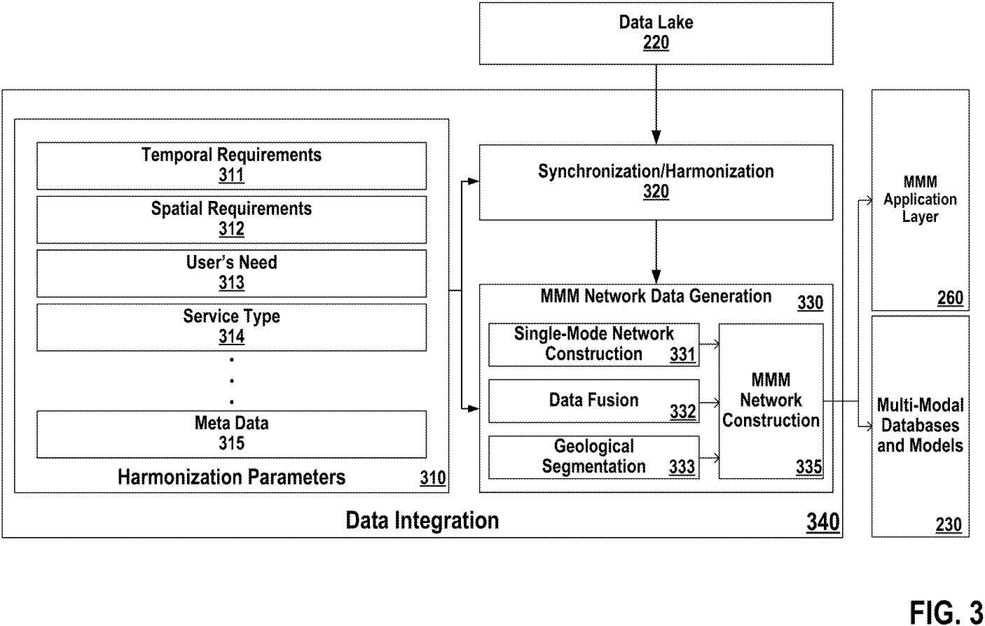

FIG. 3 illustrates an embodiment of a data integration component 340 in accordance with various aspects of the present disclosure. FIG. 3 illustrates that the data integration component 340 may include a set of harmonization parameters 310, a synchronization/harmonization component 320, and a MMM network data generation component 330. The data integration component 340 illustrated in FIG. 3 is an example implementation of the data integration component 240 of FIG. 2. As illustrated in FIG. 2, the data integration component 340 receives data from the data lake 220 and provides data for the multi-modal databases and models 230 and to MMM application layer 260.

The harmonization parameters 310 may be received, or generated, for specific analytical problems. The harmonization parameters 310 may be based on a granularity of a problem. An example analytic problem may be a demand forecast that may have different requirements (e.g., harmonization parameters) depending on a particular demand forecast problem to be solved. For example, if an hourly forecast problem is specified, the temporal requirement (parameter) associated with the hourly forecast problem may specify to aggregate data hourly as opposed to aggregating the data at a lower granularity such as daily. For the same hourly forecast problem, a set of spatial requirements (parameters) may also depend on the desired spatial granularity or scope of the forecast, e.g., at the level of a single station, a neighborhood, a city, and so on.

The harmonization parameters 310 may include temporal requirements 311 and spatial requirements 312 associated with one or more problems defined by a user or by the MMM application layer 260. For example, for dynamic schedules of a public transport mode the temporal requirement 311 and the spatial requirements 312 to harmonize data for 1) daily and/or hourly temporal scales for different routes and 2) spatially for their demand of reachable areas. In another example, for a long-term planning problem the temporal requirement 311 and the spatial requirements 312 may be specified for monthly and/or yearly temporal level and for a station, mode, and/or area spatial level

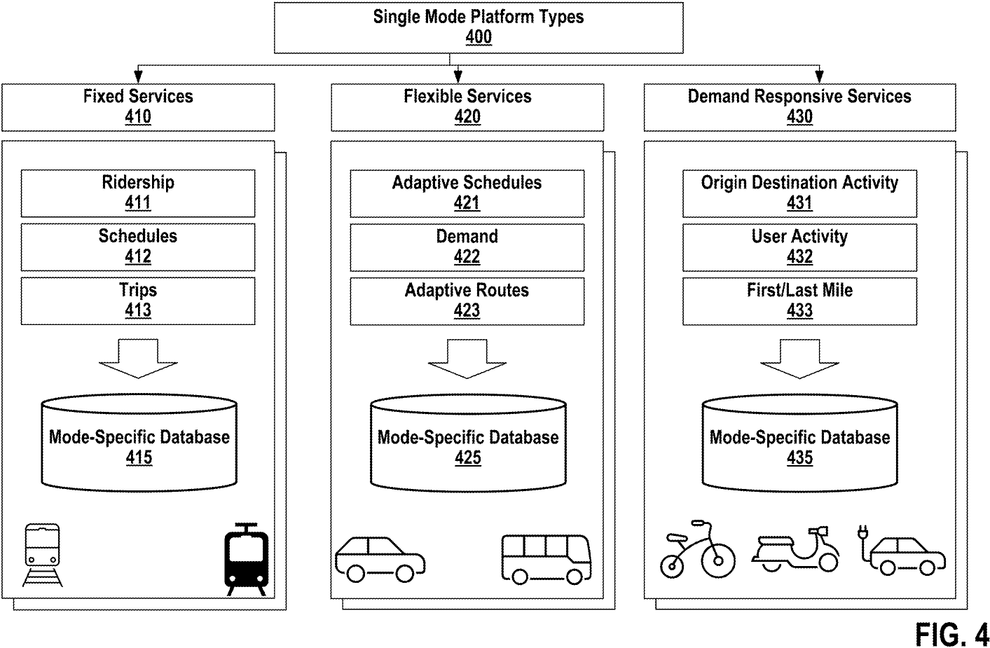

The harmonization parameters 310 may also include user preference data 313 that may be received from the preferences of users. The user preference data 313 can be used to provide a personalized experience for users. For example, for a multi-mode trip, user preference data 313 may include a user cost, a time, a mode preference, or other user-specified or inferred preference. The harmonization parameters 310 may also include service type data 314 indicating one or more service type preferences associated with one or more problems defined by a user or by the MMM application layer 260. A service type included in service type data 314 may be categorized into demand responsive services, fixed services, or flexible services as will be discussed in relation to FIG. 4. The service type associated with a specific problem in service type data 314 may affect the data fusion, feature extraction, data integration, and single-mode models. As an example, a demand forecast model associated with demand responsive services may be addressed in a different way (e.g., based on localized services) than a demand forecast model associated with fixed services (e.g., based on global flow analysis of routes) like public transportation.

The harmonization parameters 310 may also include meta data 315. The meta data 315 may include any kind of information that describes a specific mode of transportation in addition to infrastructure data and operational data. For example, the meta data 315 may include information about how a specific mode is managed and/or how the assets associated with the specific mode are handled, e.g., associated with a facility score, amenities, or other additional data that may not traditionally be associated with the basic transportation functionality. For example, a facility score for a particular asset (e.g., a node or route segment such as stations, amenities, vehicles, rails, parking lots, roads, etc.) associated with a transportation mode (e.g., demand responsive services, fixed services, or flexible services such as personal vehicles, e-scooters, ride-hailing services, buses, trains, ride sharing, etc.) may be based on key performance indicators (KPIs) or feedback from users associated with one or more factors such as safety, reliability, on time service, or other factor related to a user experience.

The harmonization parameters 310 may be provided to the synchronization/harmonization component 320 and to the MMM network data generation component 330. The synchronization/harmonization component 320 may receive data from the data lake 220 regarding the multiple modes of transportation including operation data 221, infrastructure data 222, external data 223 and user data 224. The synchronization and/or harmonization of the data received from the data lake 220 may be based, at least in part, on the harmonization parameters 310 that are in turn based on a set of user-defined, or application-defined, problems. The synchronization and/or harmonization may be performed for multiple aspects, e.g., temporal, spatial and modal aspects.

The synchronized and/or harmonized data may then be provided to the MMM network data generation component 330 to be used to generate information for the multi-modal databases and models 230 and the MMM application layer 260. The MMM network data generation component 330 may include a single-mode network construction component 331 that generates information to be stored in the set of single-mode databases (e.g., the single-mode databases 231) of the multi-modal databases and models 230. The MMM network data generation component 330 may also include a data fusion component 332. The data fusion component 332 may integrate multiple data sources to produce more consistent, accurate, and/or useful information than that provided by any individual data source. For example, for a particular asset (e.g., a node or edge of a transportation network), an asset score may be received from user data 224, a demand (e.g., based on gated entries and cameras, or e-ticketing, no of trips, etc.) may be received from operation data 221, and additional data may be received from infrastructure data 222 and/or from external data 223. The data received at data fusion component 332 may be fused/aggregated to build a vector (a database entry with a plurality of fields) to describe the asset. Additionally, the synchronized and/or harmonized data from the synchronization/harmonization component 320 may provide spatial-temporal features to describe the transportation network assets. For example, a demand for each of multiple assets (e.g., stations, vehicles, roads, etc.) may be generated as time series data showing the demand through time.

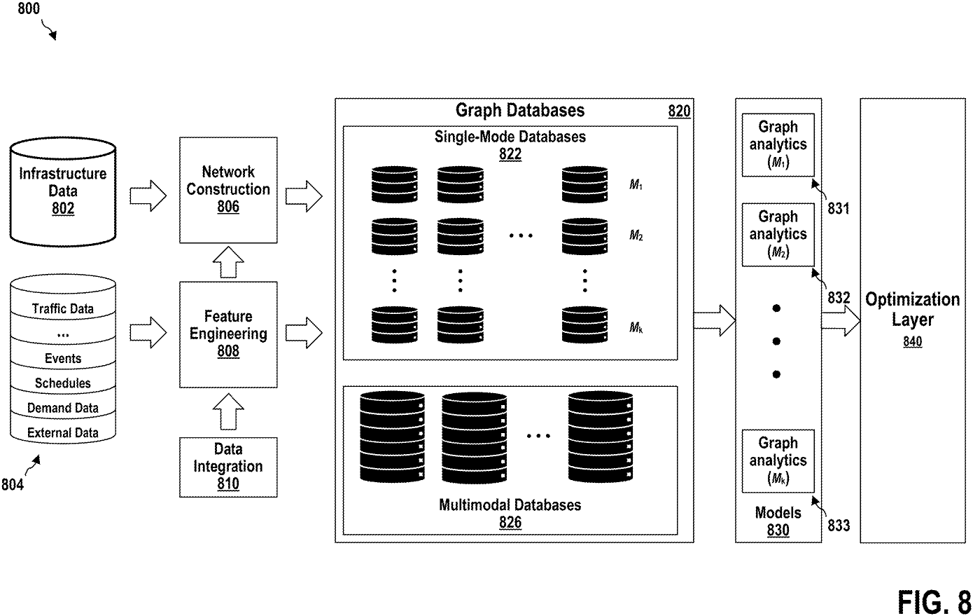

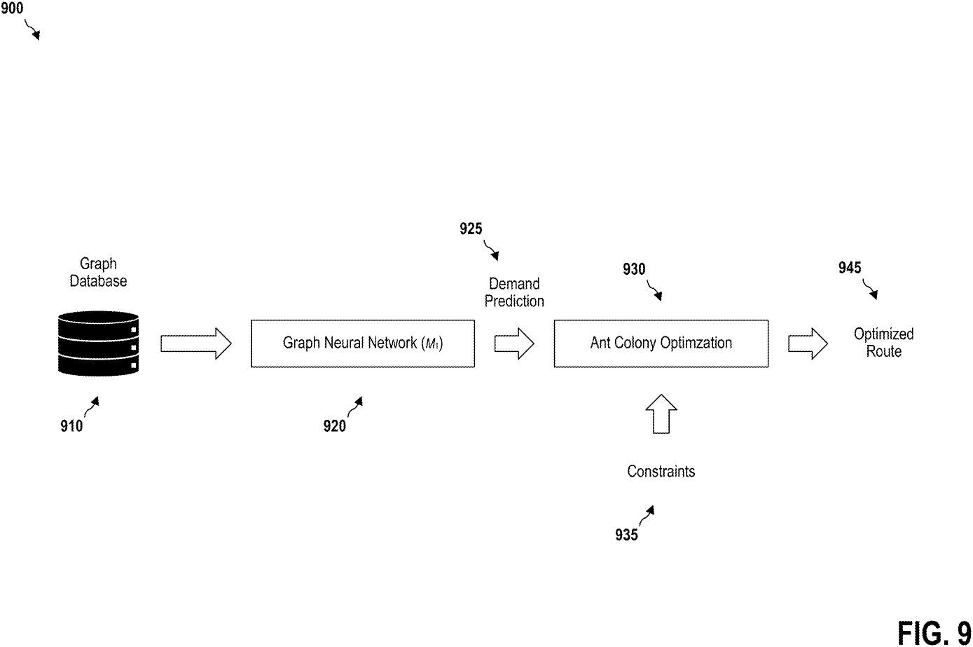

The MMM network data generation component 330 may also include a geological segmentation component 333. The geological segmentation component 333 may identify a plurality of geographical segments (at one or more granularities) and modes of transportation associated with each identified segment. In some aspects, the identified geographical segments may indicate areas belonging to the operation area of the multimodal transportation network. This segmentation, in some aspects, may help to scale the analytics for different spatial levels. A specific segment may be defined based on, or may be associated with, transportation resources inside it. An example, of geological segmentation will be discussed in more detail in relation to FIGS. 8 and 9. Based on the output of each of the single-mode network construction component 331, the data fusion component 332, and the geological segmentation component 333, the MMM network construction component 335 may generate a MMM network (e.g., a graph representing the multi-modal transportation network).

The data generated by MMM network data generation component 330 may then be provided to multi-modal databases and models 230 and the MMM application layer 260 for providing analysis. The multi-modal databases and models 230 may include databases cleaned and organized to describe a multi-modal network. In some aspects, the databases include an integration of different sources to describe a transportation network. The multi-modal databases and models 230 may include databases for a single-mode transportation network that may describe the assets and relationships between assets for a single mode of transportation. For example, for a train system, a set of stations, routes, ridership data, scheduling, etc. may be included in the single-mode database associated with the train system and may be integrated into the multi-modal database (e.g., multi-modal database 233).

FIG. 4 illustrates a set of single mode platform types 400. The single platform types 400 may include fixed services 410, flexible services 420, and demand responsive services 430. Each type of service may include multiple separate services. Fixed services 410, in some aspects, may include different types of public transportation such as bus, commuter rail, rapid transits, and so on. Generally, fixed services may operate on a predetermined route according to a predetermined schedule such that these types of systems have fixed timetables and designated stops. In some aspects, this type of transportation may benefit from a global view rather than a local view of the transportation network to provide better and/or optimized services. A fixed service 410 may be associated with ridership data 411, schedule data 412, and trip data 413 that may be aggregated, e.g., by MMM network data generation component 330, into a mode-specific database 415.

Flexible services 420, in some aspects, may include public and/or private transportation services that may have a number of passengers that is less than fixed services but more than demand responsive services. For example, buses or minivans used to transport passengers from less populated areas to more populated areas may be examples of flexible services. Often a flexible model is used to gain efficiency over a more rigid service type. A flexible service 420 may be replaced by a fixed-route service when ridership increases enough to justify the replacement. A flexible service 420 may be associated with adaptive schedule data 421, demand data 422, and adaptive route data 423 that may be aggregated, e.g., by MMM network data generation component 330, into a mode-specific database 425.

Demand responsive services 430, in some aspects, may involve small or medium vehicles operating based on a passenger request and/or demand. The demand-response model, in some aspects, allows passengers to use the demand responsive transit service for a particular date and time. Demand-response vehicles may pick up multiple passengers at several different locations before taking them to their destinations. Example of demand responsive services 430 may include e-scooters, e-bikes, walking, a road network for driving and walking, or ride-hailing services that, in some aspects, provide a platform for a passenger to request a service on demand. Demand responsive services 430 may benefit from a local view of network to identify a need associated with each area identified by a geological segmentation operation. Additionally, the utilization of demand responsive services 430 may be significantly influenced by its interaction with public transportation, points of interest, and activity-specific data. Each service in the set of demand responsive services 430 may be associated with origin destination activity data 431, user activity 432, and first/last mile data 433, that may be aggregated, e.g., by MMM network data generation component 330, into a mode-specific database 435.

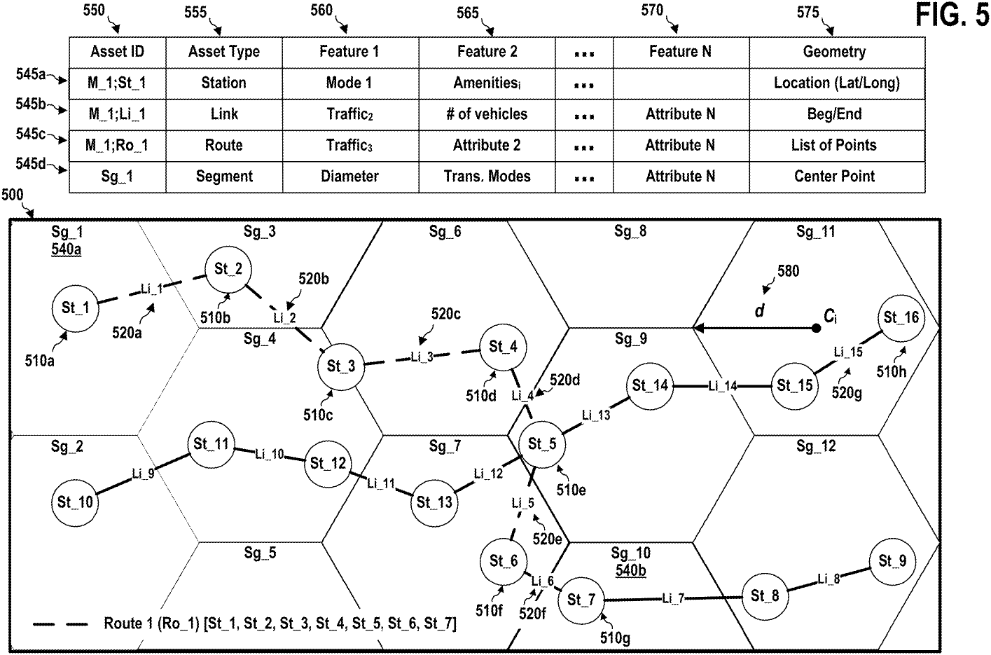

FIG. 5 illustrates a set of geographical/geological segments (Sg_1 to Sg12), including nodes (e.g., stations St_1 510a to St_16 510h), links (e.g., links Li_1 520a to Li_15 520g), and routes (e.g., Ro_1) for a portion of a single-mode transportation network 500. The portion of the single-mode transportation network 500 may be described in a set of database entries (e.g., database entries 545a-545d) of a single-mode or multi-mode transportation database. Each database entry 545a-545d may include an asset identified (ID) 550 that, for a multi-mode database, may identify a transportation mode (e.g., M1) and an asset type (e.g., St) along with an ID identifying a particular asset (e.g., St_1). In some aspects, the asset ID 550 may be a unique identifier for a particular asset that may not, in itself, identify a transportation mode or an asset type.

Each database entry in a single-mode or multi-mode transportation database may include multiple fields that may be unique to each asset and/or node type. For example, for a first entry 545a associated with a station asset (in asset-type field 555), a first field 560 may indicate a first feature (e.g., Feature 1) such as a mode associated with the station, a second field 565 may identify a second feature (e.g., Feature 2) such as a set of amenities and/or resources associated with the station, additional fields (e.g., field 3 to field N 570) that may indicate additional features (e.g., Feature N) may be specified to identify other characteristics of the station, and finally, a geometry field 575 may specify a location (e.g., latitude and longitude). For different entries 545b, 545c, 545d, the different associated fields may indicate a traffic associated with a link (e.g., Li_1) or route (e.g., Ro_1), a number of vehicles associated with a link (e.g., Li_1), a diameter ‘d’ 580 (or other size measure) of a segment (e.g., Sg_1), and a number of transportation modes (or a list of transportation modes) associated with a segment (e.g., Sg_1). Each type of asset or node may further be associated with a geometry identifying a location or a set of locations associated with the asset or node. For example, a link may be identified by nodes or points at the beginning and end of the, a route may be identified by a set of (ordered) points and/or nodes, and a segment may be identified by a center point, a geometry (e.g., hexagonal, square, rectangular, etc.), and a characteristic size (e.g., a measure ‘d’ 580). In some aspects, the segments may be specified at multiple scales and may use different units. For example, a large-scale segmentation may use zip codes, with each zip code subdivided into sub-segments at a fixed, or dynamic, number of scales, where each scale may utilize a different characteristic dimension of a same, or different, shape.

For example, the portion of the single-mode transportation network 500, may include a set of 16 stations (St_1 510a to St_16 510h) that may be identified with a set of 15 links (Li_1 520a to Li_15 520g) connecting the stations. A route (e.g., Route 1 or Ro_1) may be defined by reference to an ordered set of stations, e.g., St_1 510a to St_7 510g (as specified in the legend associated with FIG. 5), or a set of links, e.g., Li_1 520a to Li_6 520f. While the links Li_1 520a to Li_15 520g are illustrated as straight lines connecting stations St_1 510a to St_16 510h, in some aspects, the link is associated with a set of points (e.g. intersections, offramps, etc.) that define a path through a set of streets or highways that connect stations. For example, for a bus mode of transportation, the links may include information relating to a set of city streets that represent the path of the bus between stations. Although not illustrated, multiple different routes may be defined within the portion of the single-mode transportation network 500, with each route having its own entry in a corresponding single-mode and/or multi-mode transportation database.

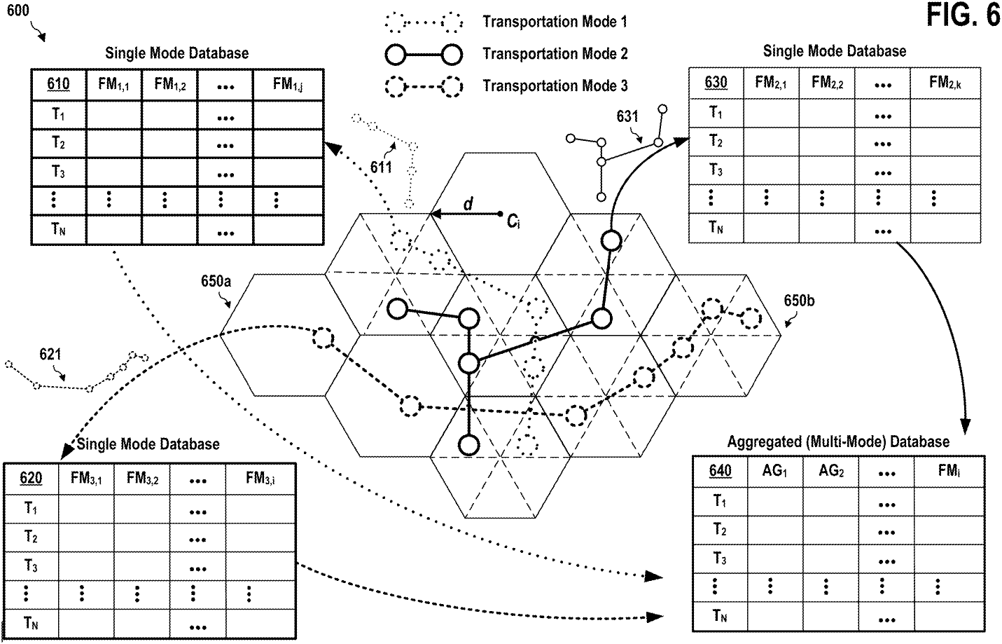

FIG. 6 is a diagram 600 illustrating a portion of a multi-mode network and associated single-mode databases 610, 620, and 630 and an aggregated (multi-mode) database 640. The multi-mode network may include a plurality of segments (e.g., segment 650a). Some of the segments may be subdivided (e.g., segment 650b) into sub-segments. For example, segments that are more densely populated with nodes of the multi-mode network may be subdivided to provide finer granularity. Each single-mode database 610, 620, and 630 may include a setof entries for elements of the corresponding single-mode network for each time period (e.g., associated with time stamps T₁ to T_{N}). The single-mode databases 610, 620, and 630 may be generated for each point or segment. The information included in the single-mode databases 610, 620, and 630 may be similar to the information included in the single-mode database of FIG. 5. The single-mode databases 610, 620, and 630 may be aggregated into the aggregated (multi-mode) database 640. Additionally, a network graph may be generated for each of the single mode networks and for the aggregated (multi-mode) network. For example, a graph 611 may be associated with the single-mode database 610, a graph 621 may be associated with the single-mode database 620, a graph 631 may be associated with the single-mode database 630, and a graph as illustrated in the segmented multi-mode network may be associated with the aggregated (multi-mode) database 640.

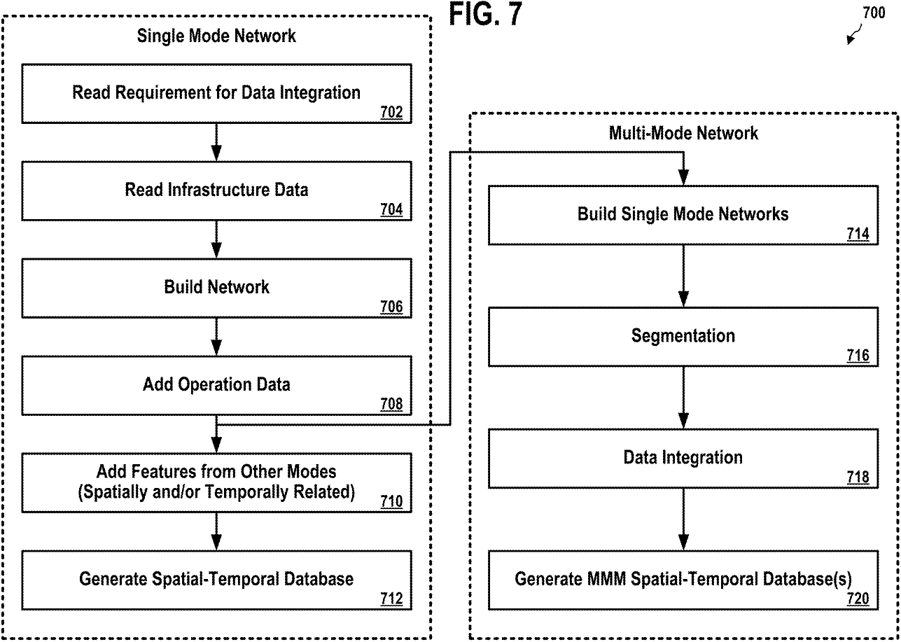

FIG. 7 is a diagram 700 illustrating a set of operations associated with building single-mode and multi-mode databases. FIG. 7 will be described in conjunction with FIG. 8. which is a diagram 800 illustrating a pipeline for providing analysis of a multi-mode transportation network. The system, at 702, may read a requirement for data integration. For example, referring to FIG. 8, the data integration information 810 may be provided to the feature engineering component 808.

Based on reading, at 702, the requirement for data integration, the system, at 704, may read infrastructure data. The infrastructure data may be read, at 704, from a database associated with a provider of a particular mode of transportation. For example, referring to FIG. 8, the infrastructure data 802 may be read based on the data integration information 810. The data may include data regarding assets associated with the mode of transportation. For example, the data may include data regarding nodes (e.g., stations, stops, etc.), links (e.g., edges, routes, etc.), and vehicles associated with the mode of transportation.

Based on the data read, at 704, regarding the infrastructure associated with the particular mode of transportation, the system, at 706, may build a network representing the infrastructure associated with the particular mode of transportation. Network construction, at 706, in some aspects includes a procedure to use each asset’s location, connections between assets, and related data to build a graph to define the transportation network. For example, referring to FIG. 8, a network construction component 806 may read infrastructure data 802 to build a network graph or generate an initial single-mode database. The graph, in some aspects, includes all edges and nodes in the network. As described in relation to FIGS. 5 and 6, the network built at 706 may identify stations, links, routes, and other infrastructure or assets and may generate a single-mode database and/or a graph associated with the particular mode of transportation.

After building the network, at 706, the system may add operation data at 708. Adding operation data 708, in some aspects, uses domain knowledge or machine learning (ML) models to extract features from raw data which are used to describe the operation of networks. For example, referring to FIG. 8, the feature engineering component 808 may extract operation data from the data sets 804 and provide the extracted feature data to the network construction component 806 to include in the single-mode database for inclusion in the set of single mode databases 822. These features improve the performance of analytics. Many features can be assigned to, or associated with, nodes (e.g., a station) and edges (e.g., links, routes, etc.). For each feature, time series data may be generated to identify changes through time. For example, the mean value of demand for a station, or a traffic over a link at different times may be associated with the station or link, respectively.

In some aspects, the system may, at 710, add features that are spatially and temporally related from other modes. The added features may, for example, be features related to demand for the other modes of transportation at different times that may affect the particular mode of transportation for which the single-mode database is being generated. For example, in generating a single-mode database for a demand responsive service, a demand at a bus or train station at different times may be relevant to determining an associated demand for the demand responsive service for ‘first/last mile’ transportation (e.g., for customers/commuters trying to get to the bus or train station from a starting location or trying to get to a final destination from the bus or train station). For example, referring to FIG. 8, the network construction component 806 may receive additional feature information regarding other modes of transportation and include it in a single-mode database in the set of single mode databases 822.

Finally, the system may generate, at 712, the spatial-temporal database for the particular mode of transportation. The spatial-temporal database may include the data described in relation to the database illustrated in FIG. 5. The spatial-temporal database may further include the information as time series data (a set of data for each of a plurality of times, e.g., time stamps T₁ to T_{N}). In some aspects, the spatial-temporal database may further include and/or be associated with a graph representing the particular mode of transportation. For example, the spatial-temporal database may be included in the set of single-mode databases 822.

Based on the operations 702-708 for generating single-mode, the system may build, at 714, single mode networks for each of a plurality of transportation modes. After building the single mode networks at 714, the system may aggregate the single-mode networks and, at 716, perform a segmentation operation. The segmentation operation performed at 716 may be performed at multiple scales. The multiple scales may be used to segment the multi-mode network based on multiple problems defined for the multi-mode network. For example, a network may be segmented as described in relation to FIGS. 5 and 6.

At 718, the system may perform a data integration to aggregate the data associated with each single-mode network generated at 714 based on the segmentation operation performed at 716. In some aspects, the data integration may be based on problem-specific information. As described in relation to FIGS. 2 and 3 the system may receive a description of a problem or a definition of a desired analysis. For example, the system may receive a specification of a problem relating to demand forecasting, traffic management, trip planning, or other desired analysis. Based on the received problem description, the data integration at 718 may identify or generate a set of harmonization and/or synchronization parameters used to integrate data from the multiple modes of transportation as described in relation to FIG. 3. In some aspects, the data integration at 718 is non-specific (e.g., generalized) and the specific problems are used to build or train an analytical model for the specific problems based on the integrated data. Based on the data integration 718, the system may generate, at 720, one or more MMM spatial-temporal databases (e.g., generalized MMM spatial-temporal databases or MMM spatial-temporal databases associated with one or more problems) for analysis. For example, referring to FIG. 8, the system may generate the set of multi-modal databases 826.

FIG. 8 further illustrates that the graph databases 820 may be used to build and/or train a set of models 830 (e.g., graph analytics 831-833). The models may represent different types of analysis of a same data set or of different data sets. For example, the models (or graph analytics) may be developed based on a time series analysis approach, or graph neural networks. Preparing the databases as graph structured data that can capture spatial-temporal dependence of locations, modes, and other elements of the multi-mode network, in some aspects, results in more accurate results. The set of models may be built or trained to use specific data from a generalized database in the graph databases 820.

The description above places no limitation on the architecture of the implementation of a data integration/exchange between different modes and the multi-mode platform. The system, in some aspects, may be centralized to collect all the data (e.g., stored in graph databases 820) and train the models 830 in one place. In some aspects, the system may be based on a decentralized approach in which all parties have access to the data, models, and consequently build their own local and private models. For example, a blockchain based infrastructure may provide a good backbone to build such framework.

Additionally, the model development and training is understood to be flexible. For example, analytics may be built and/or trained 1) on a single server based on the graph databases 820, 2) at distributed, third party, and/or local servers based on shared data from the graph databases 820, or 3) based on a federated learning approach in which models are shared with each operator for upgrading and/or retraining locally. The federated learning-based approach specifically may be useful in cases where a model is run on users’ devices and the model can be retrained for more personalized and context aware experiences.

The models 830 may then be used to provide an additional optimization layer 840. After generating an analysis based on the graph analytics (e.g., graph analytics 831-833), in some aspects, further optimization based on other variables may be provided to improve forecasting for better planning. For example, demand forecast from different modes and the interaction between modes will be used to optimize the efficiency/reliability of transportation by demand-based scheduling or route planning.

As described above, aspects of the invention provide a system that integrates a plurality of transportation modalities into a single network (e.g., based on the segmentation described in FIGS. 5 and 6) to perform different analytic tasks with a holistic view of an area and the associated transportation possibilities. Aspects of the invention presented herein further provide for modular interaction between modes to allow independent single mode analytics while also incorporating the harmonized/synchronized data from other modes. The system and methods presented herein are also applicable to different problems with different temporal and spatial scales.

FIG. 9 illustrates an example of a pipeline 900 for providing a solution to a route optimization problem for a particular mode of transportation. A graph database, or graph databases, storing the relevant information is identified at 910. The graph database may be a single-mode database enhanced with the relevant information from other modes of transportation or may be a multi-mode database as described in relation to FIGS. 7 and 8.

At 920, the system may apply a graph neural network generated (e.g., built and trained) for the route optimization problem associated with the particular mode of transportation. The graph neural network may be used to analyze the data in the identified graph database. The analysis may produce a demand prediction 925 that is provided to an optimization layer. The optimization layer may also be provided with a set of constraints 935 for the route optimization problem. The optimization layer (e.g., optimization layer 840) may then perform an optimization operation at 930 to produce an optimized route 945. For example, the optimization operation may be an ant colony optimization. For other problems, a different analysis (e.g., a different graph neural network or graph analytics) may be applied at 920 and a different optimization technique may be applied at 930 based on the type of problem to be solved.

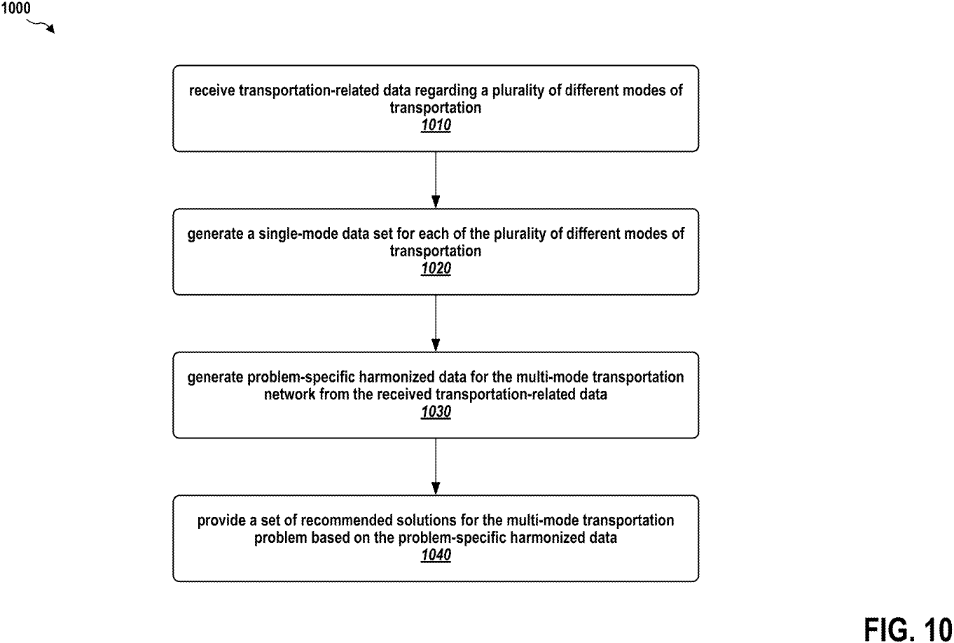

FIG. 10 is a flow diagram 1000 of a method of providing recommended solutions for a multi-mode transportation problem. The method may be performed by a system or a computer device (e.g., computer device 1205 implementing the framework 200 or the pipeline illustrated in FIG. 8). At 1010, the computer device may receive transportation-related data regarding a plurality of different modes of transportation. In some aspects, the plurality of different modes of transportation includes at least one of fixed services, variable services, and demand-responsive services. The transportation-related data, in some aspects, includes at least one of infrastructure data, or data relating to one of a link, a node, a route, or a segment. For example, referring to FIGS. 2, 7, and 8, the system may receive (or read at 704) infrastructure data 222 or 802.

At 1020, the computer device may generate a single-mode data set for each of the plurality of different modes of transportation. In some aspects, generating the single-mode data set for at least one of the plurality of different modes of transportation includes incorporating features related to data received regarding at least one other mode of transportation of the plurality of different modes of transportation. For example, referring to FIG. 7, the system may add, at 710, features from other modes that are spatially and/or temporally related to a first mode.

At 1030, the computer device may generate problem-specific harmonized data for the multi-mode transportation network from the received transportation-related data. For example, referring to FIGS. 2 and 3, the data integration component 240 and 340 may generate problem-specific harmonized data based on transportation-related data from the data lake 220. In some aspects, generating the problem-specific harmonized data for the multi-mode transportation network comprises geographical segmentation of an area associated with the multi-mode transportation network. For example, referring to FIGS. 5 and 6, the multi-mode network may be segmented into segments such as segments Sg_1 540a, Sg_10 540b, 650a, and 650b. The computer device may receive additional data from a set of non-transportation devices and use the additional data to generate the problem-specific harmonized data for the multi-mode transportation network. The additional data received from the set of non-transportation devices, in some aspects, includes at least one of weather data, demographic data, census data, user-activity data, point-of-interest data, or other data received from smart devices.

Finally, at 1040, the computer device may provide a set of recommended solutions for the multi-mode transportation problem based on the problem-specific harmonized data. In some aspects, the set of recommended solutions relates to optimizing one or more of time, distance, transportation type, or cost associated with transportation via the multi-mode network. For example, referring to FIG. 9, the system may provide route planning (e.g., the optimized route 945).

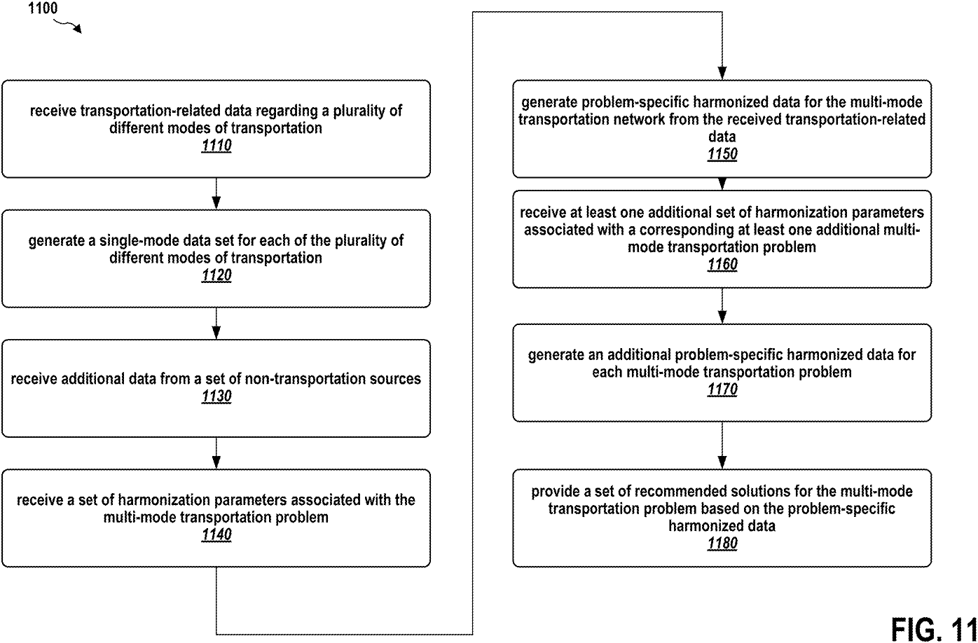

FIG. 11 is a flow diagram 1100 of a method of providing recommended solutions for a multi-mode transportation problem. The method may be performed by a system or a computer device (e.g., computer device 1205 implementing the framework 200 or the pipeline illustrated in FIG. 8). At 1110, the computer device may receive transportation-related data regarding a plurality of different modes of transportation. In some aspects, the plurality of different modes of transportation includes at least one of fixed services, variable services, and demand-responsive services. The transportation-related data, in some aspects, includes at least one of infrastructure data, or data relating to one of a link, a node, a route, or a segment. For example, referring to FIGS. 2, 7, and 8, the system may receive (or read at 704) infrastructure data 222 or 802.

At 1120, the computer device may generate a single-mode data set for each of the plurality of different modes of transportation. In some aspects, generating the single-mode data set for at least one of the plurality of different modes of transportation includes incorporating features related to data received regarding at least one other mode of transportation of the plurality of different modes of transportation. For example, referring to FIG. 7, the system may add, at 710, features from other modes that are spatially and/or temporally related to a first mode.

At 1130, the computer device may receive additional data from a set of non-transportation sources (e.g., IoT devices and external data resources) and use the additional data to generate the problem-specific harmonized data for the multi-mode transportation network. The additional data received from the set of non-transportation sources (e.g., IoT devices and external data resources), in some aspects, includes at least one of weather data, demographic data, census data, user-activity data, point-of-interest data, or other data received from smart devices. For example, referring to FIGS. 2, 3, and 8, the framework 200 may receive external data 223 or additional data from the data sets 804.

At 1140, the computer device may receive a set of harmonization parameters associated with the multi-mode transportation problem. The set of harmonization parameters may include temporal parameters (e.g., indicating a temporal scale of the problem), a set of spatial parameters (e.g., indicating a spatial scale of the problem), user preference parameters, service type parameters, and other parameters related to the specific problem to be solved. For example, referring to FIG. 3, the data integration component 340 may receive a set of harmonization parameters 310 including one or more of temporal requirements 311, spatial requirements 312, user preference data 313, service type data 314, and/or meta data 315.

At 1150, the computer device may generate problem-specific harmonized data for the multi-mode transportation network from the received transportation-related data. The computer device may generate the problem-specific harmonized data based on the set of harmonization parameters associated with the multi-mode transportation problem received at 1140. For example, referring to FIGS. 2 and 3, the data integration component 240 and 340 may generate problem-specific harmonized data based on transportation-related data from the data lake 220. In some aspects, generating the problem-specific harmonized data for the multi-mode transportation network comprises geographical segmentation of an area associated with the multi-mode transportation network. For example, referring to FIGS. 5 and 6, the multi-mode network may be segmented into segments such as segments Sg_1 540a, Sg_10 540b, 650a, and 650b.

At 1160, the computer device may receive at least one additional set of harmonization parameters associated with a corresponding at least one additional multi-mode transportation problem. The at least one additional set of harmonization parameters may include a different set of temporal parameters (e.g., indicating a temporal scale of the problem), a set of spatial parameters (e.g., indicating a spatial scale of the problem), user preference parameters, service type parameters, and other parameters related to the specific problem to be solved. For example, referring to FIG. 3, the data integration component 340 may receive an additional set of harmonization parameters 310 associated with at least one additional multi-mode transportation problem, the additional set of harmonization parameters 310 may also include one or more of temporal requirements 311, spatial requirements 312, user preference data 313, service type data 314, and/or meta data 315.

At 1170, the computer device may generate an additional problem-specific harmonized data for each multi-mode transportation problem of the at least one additional multi-mode transportation problems. Each additional problem-specific harmonized data may be based on a different set of transportation-related data (e.g., transportation-related data associated with one or more of a different mode of transportation, a different spatial scale, or a different temporal scale). For example, a first additional problem-specific harmonized data may be based on data related to a bus system for analysis of a single zip code and organized by the minute, while a second additional problem-specific harmonized data may be based on data related to a same, or different, bus system for analysis of a county including multiple zip codes and organized by the day (or hour). The computer device may generate the additional problem-specific harmonized data for each multi-mode transportation problem of the at least one additional multi-mode transportation problems based on the at least one additional set of harmonization parameters associated with the corresponding multi-mode transportation problem received at 1160. For example, referring to FIGS. 2 and 3, the data integration component 240 and 340 may generate additional problem-specific harmonized data based on transportation-related data from the data lake 220. In some aspects, generating the problem-specific harmonized data for the multi-mode transportation network comprises geographical segmentation of an area associated with the multi-mode transportation network. For example, referring to FIGS. 5 and 6, the multi-mode network may be segmented into segments such as segments Sg_1 540a, Sg_10 540b, 650a, and 650b.

Finally, at 1180, the computer device may provide a set of recommended solutions for the multi-mode transportation problem based on the problem-specific harmonized data. In some aspects, the set of recommended solutions relates to optimizing one or more of time, distance, transportation type, or cost associated with transportation via the multi-mode network. For example, referring to FIG. 9, the system may provide route planning (e.g., optimized route 945).

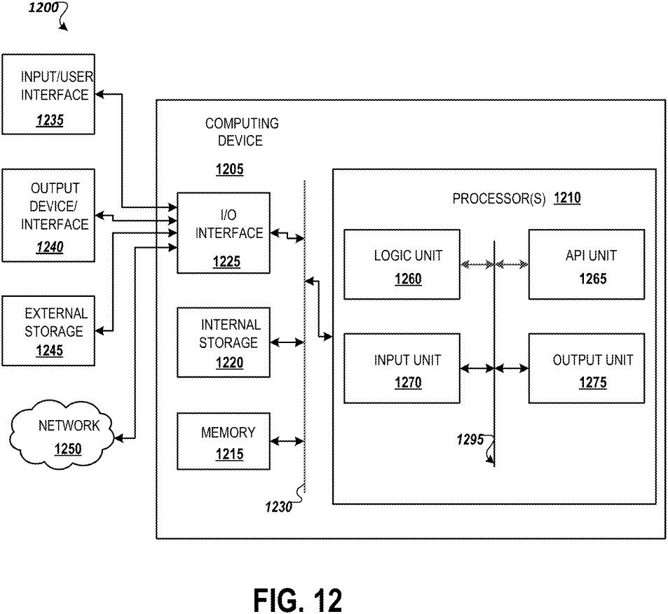

FIG. 12 illustrates an example computing environment with an example computer device suitable for use in some example implementations. Computer device 1205 in computing environment 1200 can include one or more processing units, cores, or processors 1210, memory 1215 (e.g., RAM, ROM, and/or the like), internal storage 1220 (e.g., magnetic, optical, solid-state storage, and/or organic), and/or IO interface 1225, any of which can be coupled on a communication mechanism or bus 1230 for communicating information or embedded in the computer device 1205. IO interface 1225 is also configured to receive images from cameras or provide images to projectors or displays, depending on the desired implementation.

Computer device 1205 can be communicatively coupled to input/user interface 1235 and output device/interface 1240. Either one or both of the input/user interface 1235 and output device/interface 1240 can be a wired or wireless interface and can be detachable. Input/user interface 1235 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1240 may include a display, television, monitor, printer, speaker, braille, or the like. In some example implementations, input/user interface 1235 and output device/interface 1240 can be embedded with or physically coupled to the computer device 1205. In other example implementations, other computer devices may function as or provide the functions of input/user interface 1235 and output device/interface 1240 for a computer device 1205.

Examples of computer device 1205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1205 can be communicatively coupled (e.g., via IO interface 1225) to external storage 1245 and network 1250 for communicating with any number of networked components, devices, and systems, including one or more computer devices of the same or different configuration. Computer device 1205 or any connected computer device can be functioning as, providing services of, or referred to as a server, client, thin server, general machine, special-purpose machine, or another label.

IO interface 1225 can include but is not limited to, wired and/or wireless interfaces using any communication orIO protocols or standards (e.g., Ethernet, 1202.11x, Universal System Bus, WiMax, modem, a cellular network protocol and the like) for communicating information to and/or from at least all the connected components, devices, and network in computing environment 1200. Network 1250 can be any network or combination of networks (e.g., the Internet, local area network, wide area network, a telephonic network, a cellular network, satellite network, and the like).

Computer device 1205 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1210 can execute under any operating system (OS) (not shown), in a native or virtual environment. One or more applications can be deployed that include logic unit 1260, application programming interface (API) unit 1265, input unit 1270, output unit 1275, and inter-unit communication mechanism 1295 for the different units to communicate with each other, with the OS, and with other applications (not shown). The described units and elements can be varied in design, function, configuration, or implementation and are not limited to the descriptions provided. Processor(s) 1210 can be in the form of hardware processors such as central processing units (CPUs) or in a combination of hardware and software units.

In some example implementations, when information or an execution instruction is received by API unit 1265, it may be communicated to one or more other units (e.g., logic unit 1260, input unit 1270, output unit 1275). In some instances, logic unit 1260 may be configured to control the information flow among the units and direct the services provided by API unit 1265, the input unit 1270, the output unit 1275, in some example implementations described above. For example, the flow of one or more processes or implementations may be controlled by logic unit 1260 alone or in conjunction with API unit 1265. The input unit 1270 may be configured to obtain input for the calculations described in the example implementations, and the output unit 1275 may be configured to provide an output based on the calculations described in example implementations.

Processor(s) 1210 can be configured to receive transportation-related data regarding a plurality of different modes of transportation. The processor(s) 1210 may also be configured to generate a single-mode data set for each of the plurality of different modes of transportation. Processor(s) 1210 may, in some aspects, be configured to generate problem-specific harmonized data for the multi-mode transportation network from the received transportation-related data. The processor(s) 1210 may further be configured to provide a set of recommended solutions for the multi-mode transportation problem based on the problem-specific harmonized data.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining” “displaying,” or the like, can include the actions and processes of a computer system or other information processing device that manipulates and transforms data represented as physical (electronic) quantities within the computer system’s registers and memories into other data similarly represented as physical quantities within the computer system’s memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed:

1. A method of providing recommended solutions for a multi-mode transportation problem associated with a multi-mode transportation network, comprising:
receiving transportation-related data regarding a plurality of different modes of transportation;
generating a single-mode data set for each of the plurality of different modes of transportation;
generating problem-specific harmonized data for the multi-mode transportation network from the received transportation-related data; and
providing a set of recommended solutions for the multi-mode transportation problem based on the problem-specific harmonized data.

2. The method of claim 1, wherein generating the single-mode data set for at least one of the plurality of different modes of transportation comprises including features related to data received regarding at least one other mode of transportation of the plurality of different modes of transportation.

3. The method of claim 1, further comprising:
receiving additional data from a set of external data resources and IoT devices, wherein the additional data is used in generating the problem-specific harmonized data for the multi-mode transportation network.

4. The method of claim 3, wherein the transportation-related data includes at least one of infrastructure data, or data relating to one of a link, a node, a route, or a segment, and wherein the additional data received from the set of external data resources and IoT devices includes at least one of weather data, demographic data, census data, user-activity data, point-of-interest data, or other data received from smart devices.

5. The method of claim 1, wherein the plurality of different modes of transportation includes at least one of fixed services, variable services, and demand-responsive services.

6. The method of claim 1, wherein generating the problem-specific harmonized data for the multi-mode transportation network comprises geographical segmentation of an area associated with the multi-mode transportation network.

7. The method of claim 1, further comprising:
receiving a set of harmonization parameters associated with the multi-mode transportation problem, wherein generating the problem-specific harmonized data for the multi-mode transportation network is based on the received set of harmonization parameters.

8. The method of claim 7, further comprising:
receiving at least one additional set of harmonization parameters associated with a corresponding at least one additional multi-mode transportation problem; and
generating an additional problem-specific harmonized data for each multi-mode transportation problem of the at least one additional multi-mode transportation problem based on the corresponding set of harmonization parameters of the at least one additional set of harmonization parameters.

9. The method of claim 1, wherein the set of recommended solutions relates to optimizing one or more of time, distance, transportation type, or cost.

10. An apparatus for providing recommended solutions for a multi-mode transportation problem associated with a multi-mode transportation network, comprising:
a memory; and
at least one processor coupled to the memory configured to:
receive transportation-related data regarding a plurality of different modes of transportation;
generate a single-mode data set for each of the plurality of different modes of transportation;
generate problem-specific harmonized data for the multi-mode transportation network from the received transportation-related data; and
provide a set of recommended solutions for the multi-mode transportation problem based on the problem-specific harmonized data.

11. The apparatus of claim 10, wherein the at least one processor is configured to generate the single-mode data set for at least one of the plurality of different modes of transportation by including features related to data received regarding at least one other mode of transportation of the plurality of different modes of transportation.

12. The apparatus of claim 10, wherein the at least one processor is further configured to:
receive additional data from a set of external data resources and IoT devices, wherein the additional data is used in generating the problem-specific harmonized data for the multi-mode transportation network.

13. The apparatus of claim 12, wherein the transportation-related data includes at least one of infrastructure data, or data relating to one of a link, a node, a route, or a segment, and wherein the additional data received from the set of external data resources and IoT devices includes at least one of weather data, demographic data, census data, user-activity data, point-of-interest data, or other data received from smart devices.

14. The apparatus of claim 10, wherein the plurality of different modes of transportation includes at least one of fixed services, variable services, and demand-responsive services.

15. The apparatus of claim 10, wherein generating the problem-specific harmonized data for the multi-mode transportation network comprises geographical segmentation of an area associated with the multi-mode transportation network.

16. The apparatus of claim 10, wherein the at least one processor is further configured to:
receive a set of harmonization parameters associated with the multi-mode transportation problem, wherein generating the problem-specific harmonized data for the multi-mode transportation network is based on the received set of harmonization parameters.

17. The apparatus of claim 16, wherein the at least one processor is further configured to:
receive at least one additional set of harmonization parameters associated with a corresponding at least one additional multi-mode transportation problem; and
generate an additional problem-specific harmonized data for each multi-mode transportation problem of the at least one additional multi-mode transportation problem based on the corresponding set of harmonization parameters of the at least one additional set of harmonization parameters.

18. The apparatus of claim 10, wherein the set of recommended solutions relates to optimizing one or more of time, distance, transportation type, or cost.

19. A non-transitory computer readable medium storing a program for providing recommended solutions for a multi-mode transportation problem associated with a multi-mode transportation network, the program comprising instructions that when executed by at least one processor causes the at least one processor to:
receive transportation-related data regarding a plurality of different modes of transportation;
generate a single-mode data set for each of the plurality of different modes of transportation;
generate problem-specific harmonized data for the multi-mode transportation network from the received transportation-related data; and
provide a set of recommended solutions for the multi-mode transportation problem based on the problem-specific harmonized data.

20. The non-transitory computer readable medium of claim 19, wherein generating the problem-specific harmonized data for the multi-mode transportation network comprises geographical segmentation of an area associated with the multi-mode transportation network.
